(19) United States
(12) Patent Application Publication
(10) Pub. No.: US 2007/0098340 A1
(43) Pub. Date: May 3, 2007

(54) Tube for installing an optical fiber unit having a lubricous surface

(76) Inventors: Bong-Hoon Lee, Gyeonggi-do (KR); Chan-Yong Park, Seoul (KR); Yeon-Su Ahn, Gteonggi-do (KR)

Correspondence Address: JONES DAY, 222 EAST 41ST ST, NEW YORK, NY, 10017, US

(21) Appl. No.: 10/562,479

(22) PCT Filed: Sep. 30, 2003
(86) PCT No.: PCT/KR03/02003

§ 371 Date: Dec. 23, 2005

(30) Foreign Application Priority Data
Jun. 27, 2003 (KR) 10-2003-0042528

(51) Int. Cl. G02B 6/44

(52) U.S. Cl. 385/109; 385/112; 385/113

(57) ABSTRACT

Disclosed is a tube for installing an optical fiber unit having lubricous surface, which is installed in a communication pipe. The tube for installation includes an inner layer having lubricant components to decrease friction against an optical fiber unit, and an outer layer provided around the inner layer and composed of polymer having a lower friction coefficient than polyethylene so as to decrease friction when the tube is installed in the communication pipe. The tube is easier to install than the conventional one due to decreased friction against the communication pipe.

### TECHNICAL FIELD

The present invention relates to an installation tube used for an optical fiber unit installation method using gas pressure.

### BACKGROUND ART

An optical fiber unit installation method using gas pressure is installing a micro tube or duct for installation (hereinafter, referred to as ‘an installation tube’) at an optical fiber unit installation position in advance, and then installing an optical fiber unit into the installation tube with the use of gas pressure. This method allows easy installation and removal of an optical fiber unit and requires a low cost for construction, so it is widely used for installing an optical fiber unit in a narrow space like FTTH (Fiber To The Home).

Generally in the gas pressure installation method, an optical fiber unit having 1- to 12-core optical fiber, called ABF (Air Blown Fiber), is inserted into the installation tube with the use of an optical fiber unit installation apparatus as shown in FIG. 1.

Referring to FIG. 1, the optical fiber unit installation apparatus includes a blowing head 20 to which an installation tube 10 is connected, an optical fiber unit supplier 30 for supplying an optical fiber unit 1 to the blowing head 20, and a gas supplier 40 for injecting a compressed gas into the blowing head 20 so that the optical fiber unit 1 is installed along the inside of the installation tube 10.

The installation tube 10 is installed in a predetermined communication pipe 50 as shown in FIG. 2 in advance, and a steel or PVC tube with a size of 16 to 22 mm is generally used for the installation tube 10.

However, if the communication pipe 50 has a length longer than a certain level or communication lines such as UTP (Unshielded Twisted Pair) cable are already installed in the communication pipe 50, the installation tube 10 may not be easily installed due to the friction.

In spite of that, since the conventional installation tube 10 is composed of a sheath 10a made of polyethylene and an inner layer 10b having lubricity for decreasing the friction against the optical fiber unit 1 installed by gas pressure in consideration of only flexibility and shock resistance as shown in FIG. 3, the conventional tube 10 has various weak points caused by the frictional force when it is installed in the communication pipe.

### DISCLOSURE OF INVENTION

The present invention is designed to solve the problem of the prior art, and therefore an object of the invention is to provide a tube for gas pressure installation, which may be easily installed in a communication pipe.

In order to accomplish the above object, the present invention provides a tube for installing an optical fiber unit, which is to be installed in a communication pipe, and the tube includes an inner layer having a lubricous component for decreasing friction against the optical fiber unit; and a sheath provided around the inner layer and made of polymer with a lower coefficient of friction than polyethylene in order to decrease friction when the tube is installed in the communication pipe.

The tube preferably further includes a reinforcing layer interposed between the inner layer and the sheath so as to increase strength of the tube itself.

Preferably, the sheath includes a silicon component. Alternatively, the sheath may also include carbon or PBT (Poly Butylene Terephthalate).

In another aspect of the invention, there is also provided a tube for installing an optical fiber unit, which is to be installed in a communication pipe, wherein the tube is made of a single layer made of polymer having a lower coefficient of friction than polyethylene so as to decrease friction against the optical fiber unit contacted with an inner circumference of the tube while the optical fiber unit is installed by gas pressure as well as friction generated on an outer circumference of the tube while the tube is installed in the communication pipe.

Preferably, the single layer is composed of PBT.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic diagram showing a general optical fiber unit installation apparatus;

FIG. 2 is a schematic diagram showing that an installation tube is installed in a communication pipe according to the prior art;

FIG. 3 is a sectional view showing a tube for installing an optical fiber unit according to the prior art;

FIG. 4 is a sectional view showing a tube for installing an optical fiber unit according to one embodiment of the present invention;

FIG. 5 is a sectional view showing a tube for installing an optical fiber unit according to another embodiment of the present invention;

FIG. 6 is a sectional view showing a modification of the tube shown in FIG. 5; and

FIG. 7 is a sectional view showing a tube for installing an optical fiber unit according to still another embodiment of the present invention.

### BEST MODES FOR CARRYING OUT THE INVENTION

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

FIG. 4 is a sectional view showing a tube for installing an optical fiber unit according to one embodiment of the present invention.

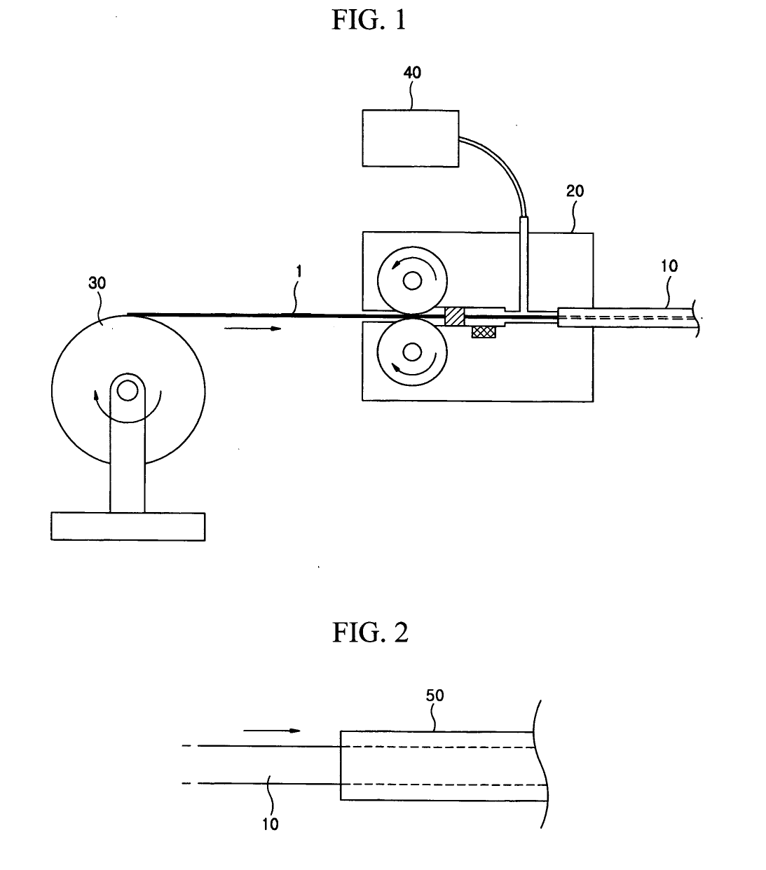

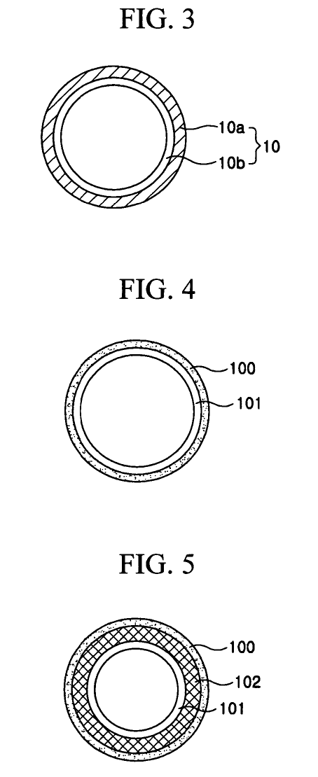

Referring to FIG. 4, the tube for installing an optical fiber unit according to the present invention includes an inner layer 101 directly contacted with an optical fiber unit 1 (see FIG. 1) while the optical fiber unit is installed by gas pressure, and a sheath 100 provided around the inner layer 101 and made of polymer having a lower coefficient of friction than polyethylene.

The inner layer 101 is preferably made of polymer having a lubricous component so as to decrease friction against the optical fiber unit 1 during the gas pressure installation. The inner layer 101 is also preferably made of polyethylene containing silicon or carbon, but other well-known materials may also be selected.

The sheath 100 is preferably made of polymer having a lower coefficient of friction than polyethylene under the same condition so as to decrease friction against an inner wall of a communication pipe or a communication cable already installed in the communication pipe while the tube for installing an optical fiber unit according to the present invention is installed in the communication pipe. For this purpose, the sheath 100 is preferably made of polyethylene containing a lubricous component such as silicon, carbon and PBT (Poly Butylene Terephthalate).

Between the inner layer 101 and the sheath 100, a reinforcing layer 102 may be interposed as shown in FIG. 5 so as to increase strength of the tube itself. The reinforcing layer 102 is preferably made of a material with good shock resistance such as polyethylene, and a tensile strength of the reinforcing layer 102 is preferably higher than 20 MPa for effectively increasing the strength of the tube.

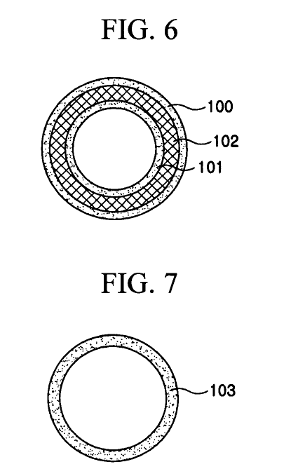

As a modification of the tube according to the present invention, the inner layer 101 and the sheath 100 may be made of the same lubricous material as shown in FIG. 6.

FIG. 7 is a sectional view showing a tube for installing an optical fiber unit according to another embodiment of the present invention.

Referring to FIG. 7, the tube for installing an optical fiber unit according to this embodiment includes only a single layer 103 having lubricity. The single layer 103 decreases the friction against the optical fiber unit contacted with an inner circumference of the tube while the optical fiber unit is installed by gas pressure as well as the friction generated on an outer circumference of the tube while the tube is installed in the communication pipe.

The single layer 103 is preferably made of polymer having a lower coefficient of friction than polyethylene under the same condition. For example, the single layer 103 may be made of PBT.

Now, operation of the tube configured as mentioned above according to the present invention will be described.

The tube for installing an optical fiber unit according to the present invention is installed in a predetermined communication pipe 50 in advance for executing the installation method using gas pressure. The tube for installing an optical fiber unit is installed in the communication pipe by pushing the tube into an empty space in the communication pipe. At this time, since the tube has lubricity on its outer circumference, it may be smoothly advanced along the inside of the communication pipe though its outer surface is contacted with various communication cables or an inner wall of the communication pipe.

An optical fiber unit for gas pressure installation is installed in the tube. At this time, since the tube has lubricity on its inner circumference, the optical fiber unit 1 may be smoothly installed into the tube.

### INDUSTRIAL APPLICABILITY

As mentioned above, the tube for installing an optical fiber unit according to the present invention may be more easily installed in a communication pipe than the conventional one since its surface has lubricity to decrease friction.

If the present invention is applied to the optical fiber unit installation method, it is possible to extend an installation length and prevent damage of the tube, which may be caused when the tube is contacted with various communication cables in the communication pipe or the inner wall of the communication pipe.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1-8. (canceled)

9. A tube for installing an optical fiber unit, which is to be installed in a communication pipe, the tube comprising:
an inner layer defining an opening for receiving the optical fiber unit, and having a lubricous component for decreasing friction against the optical fiber unit; and
a sheath provided around the inner layer and made of polymer with a lower coefficient of friction than polyethylene in order to decrease friction when the tube is installed in the communication pipe.

10. The tube according to claim 9, further comprising a reinforcing layer interposed between the inner layer and the sheath so as to increase strength of the tube itself.

11. The tube according to claim 10 wherein the tensile strength of the reinforcing layer is higher than 20 MPa.

12. The tube according to claim 10 wherein the reinforcing layer is made of polyethylene.

13. The tube according to claim 9,
wherein the sheath includes a lubricous component so as to decrease friction between the tube and the communication pipe.

14. The tube according to claim 13,
wherein the lubricous component is silicon, carbon or PBT (Poly Butylene Terephthalate).

15. The tube according to claim 10,
wherein the sheath includes a lubricous component so as to decrease friction between the tube and the communication pipe.

16. The tube according to claim 15,
wherein the lubricous component is silicon, carbon or PBT (Poly Butylene Terephthalate).

17. The tube according to claim 9, wherein the polymer is polyethylene containing a lubricous component.

18. The tube according to claim 17, wherein the lubricous component is silicon, carbon or PBT.

19. The tube according to claim 9 wherein the inner layer and sheath are made of the same material.

20. A tube for installing an optical fiber unit, which is to be installed in a communication pipe,
wherein the tube is made of a single layer made of polymer having a lower coefficient of friction than polyethylene so as to decrease friction against the optical fiber unit contacted with an inner circumference of the tube while the optical fiber unit is installed by gas pressure as well as friction generated on an outer circumference of the tube while the tube is installed in the communication pipe.

21. The tube according to claim 20, wherein the single layer is composed of PBT.
